(19) United States
(12) Patent Application Publication
(10) Pub. No.: US 2010/0145947 A1
(43) Pub. Date: Jun. 10, 2010

(54) METHOD AND APPARATUS FOR AN INVENTIVE GEO-NETWORK

(75) Inventors: Selene J.J. Kolman, Amsterdam (NL); Stef F.G. Kolman, Amsterdam (NL); Tomas Van Der Wansem, Amsterdam (NL)

Correspondence Address: Thomas C. Tyler, 6789 Kings Way, Hudson, OH, 44236, US

(73) Assignee: BLIIN B.V., Amsterdam (NL)

(21) Appl. No.: 12/630,891

(22) Filed: Dec. 4, 2009

Related U.S. Application Data
(60) Provisional application No. 61/120,336, filed on Dec. 5, 2008.

(51) Int. Cl. G06F 17/30

(52) U.S. Cl. 707/736; 707/E17.001

(57) ABSTRACT

A system and a method for communication using geo-tagged data among a plurality of communication devices in an inventive geo-network, using a communications network, are described. The method further facilitates enabling multiple networks within the network such that each network separately and securely enables the collection, distribution, and display of data and location-enriched geo-data.

### I. BACKGROUND

A. Field of Invention

This invention generally pertains to the art of methods and apparatuses of telecommunications, and more specifically to the art of methods and apparatuses of facilitating and implementing a substantially continuous network utilizing electronic communication devices capable of enabling multiple networks within the network wherein each network separately enables the collection, distribution, and display of data and location-enriched geo-data.

B. Description of the Related Art

This invention is set against the backdrop of a trend towards an ubiquitous near real-time online network of telematic connectivity. The invention is dealing with the situation where processor power, satellite navigation and communication technology becomes standard equipment in our everyday lives; phones, automobiles, and other devices are part of a person's personal and professional environments.

A telepresence is envisioned whereby static and dynamic objects and people become mobile profiles, sending and receiving real-time information, and as such moving nodes in a network with ever changing locations. The entities and their inter-rangings and communications within their network can be remotely displayed and can interact remotely.

On May 1, 2000, President Bill Clinton discontinued a scramble (Selective Availability) on the Global Positioning System (GPS) in an ongoing effort to make GPS more responsive to civil and commercial users worldwide. Today with Europe's own Global Navigation Satellite System: Galileo about to become operational, we are on the threshold of a new economy coined: ‘Satellite Economy’. With tremendous speed and increasing accuracy, people, animals & objects are located, traced and presented—in real time—on some form of graphic representation of our planet.

While still relatively young, GNSS (Global Navigation Satellite Systems) services are now emerging in the mass market driven by a strong demand for location and navigation-based services, the maturing of mobile networks and handsets and the recent explosion of online communities and social networks.

### II. SUMMARY

According to an embodiment of the invention, the inventive network may comprise a system and method to securely collect, distribute, and display—in (near) real-time continuity-data and location enriched geo-data from and to electronic communication devices.

According to another embodiment of the invention, an inventive network may comprise a system and method to securely collect and distribute—in continuous (near) real-time—location enriched data (-sets & streams) displayed in an electronic communication devices' browser on a graphic representation.

One advantage of this invention is that the invention allows for the world-wide connection of people, friends, family, co-workers, equipment, objects, animals, and any other person or object that comprises geo-data by allowing users to follow the travels of other users in near real-time as users record and share uploaded geo-data.

Another advantage of this invention is that users may instantly share geo-tagged data via communication devices with viewers and other users of the network. Additionally, the invention allows users to upload the geo-data, including, but not limited to, photos, video, audio, text, and any other type of geo-data or non-geo-data chosen with sound judgment by a person of ordinary skill in the art, later from the communication device.

Another advantage of this invention is that the system may be integrated and/or interconnected with third-party systems, databases, and software to provide increased or third-party-specific content within the system.

Another advantage of this invention is that the system allows for the creation and operation of multiple, independent, closed sub-networks within the system that can be limited to a specific user-group, domain, number of users, or geographic area.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a diagram showing an operating environment for enabling an inventive network according to an embodiment of the invention;

FIG. 2 is a diagram for collecting data utilizing an inventive network according to an embodiment of the invention;

FIG. 3 is a diagram for distributing data utilizing an inventive network according to an embodiment of the invention;

FIG. 4 is a diagram showing modules of a first server according to an embodiment of the invention;

FIG. 5 is a diagram showing modules of a communication device according to an embodiment of the invention;

FIG. 6 is a diagram showing a view of a mobile user portal according to an embodiment of the invention;

FIG. 7 is a diagram showing another view of the mobile user portal according to an embodiment of the invention;

FIG. 8 is a diagram showing options available to a user of the inventive network according to an embodiment of the invention;

FIG. 9 is a diagram showing a live-line feature of the inventive network according to an embodiment of the invention;

FIG. 10 is a diagram showing a radar feature of the inventive network according to an embodiment of the invention;

FIG. 11 is a diagram showing an intelligent privacy settings feature of the inventive network according to an embodiment of the invention;

FIG. 12 is a diagram showing a collections feature of the inventive network according to an embodiment of the invention;

### IV. DETAILED DESCRIPTION

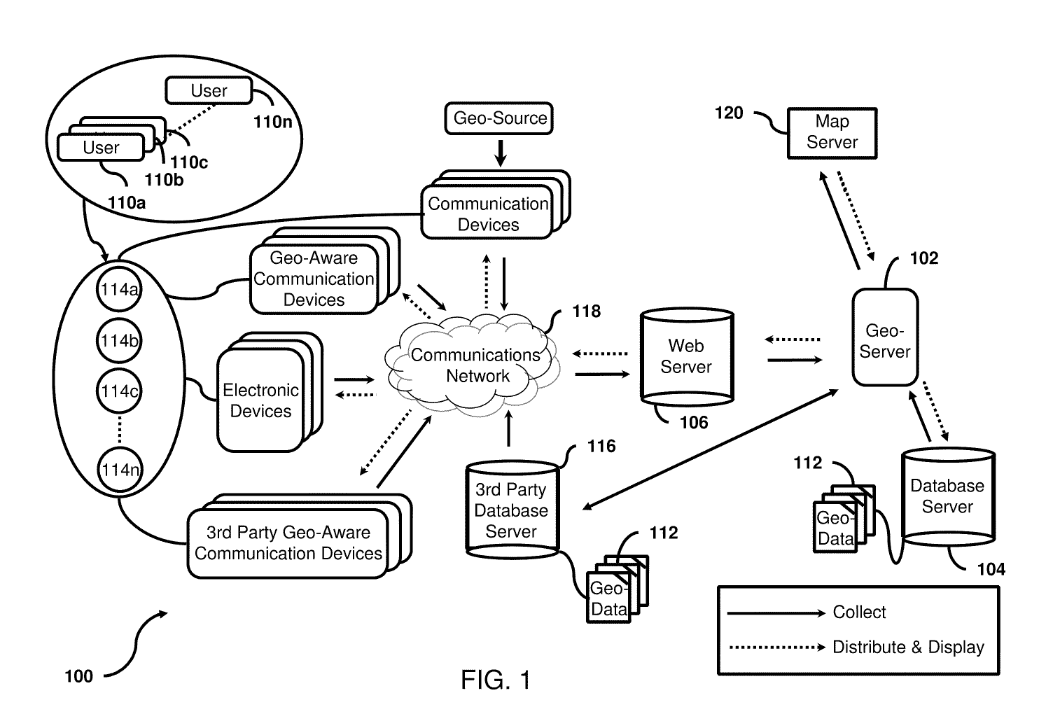

Referring now to the drawings wherein the showings are for purposes of illustrating embodiments of the invention only and not for purposes of limiting the same, FIG. 1 is a diagram showing an operating environment for enabling an inventive network according to an embodiment of the invention. The inventive network 100 may comprise a communications network 118 and a system for communication over the communications network 118 using location-enriched data, data sets, and/or media, such as, video, audio, photographs, text messages, etc., hereinafter collectively referred to as geo-tagged data 112. In one of the embodiments, the communications network 118 can be internet. In another embodiment, the communications network 118 can be a cellular network. Further, the communications network 118 can vary as per various embodiments of the present invention, for example a local area network (LAN), a wide area network (WAN), an intranet, etc. A user 110a-n may access the inventive network 100 using any one of the plurality of communication devices 110a-n connected to the communication network 118, as shown in FIG. 1.

The system for communication may include a first server which can run computer executable modules stored on a computer readable medium to implement the inventive network 100. In one of the embodiments, the first server can be a web server 106 as shown in FIG. 1. The web server 106 may include a network engine for running the server application software to implement the inventive network 100. The network engine may implement the inventive network 100 as an open community wherein the inventive network 100 may be substantially freely accessed by the public generally, as per an embodiment of the present invention. In another embodiment, the inventive network 100 may be a closed community where access to the inventive network 100 is controlled or limited to a specific population or group of users based on pre-defined settings. Further, the web server 106 may include or be in communication with a geo-server 102 which receives data and creates and stores geo-tagged data 112. The geo-server 102 may include or further be in communication with a database server 104 and a map server 120, as shown in FIG. 1. The database server 104 may be used to store the geo-tagged data 112. The map server 120 may be used to store and provide digital maps known in the prior art or custom maps as per requirement.

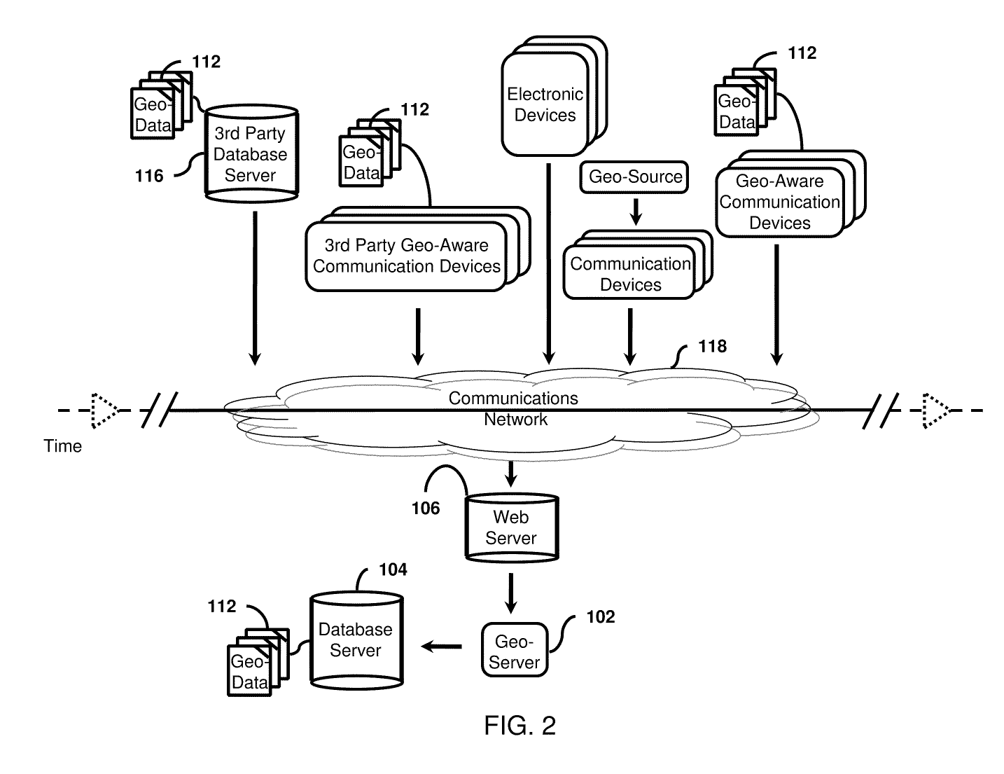

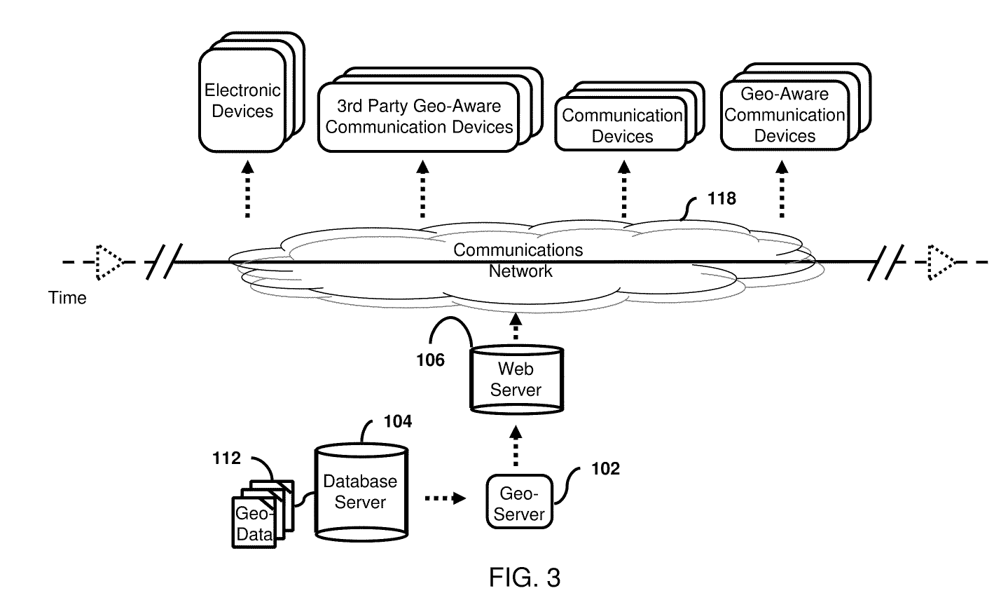

FIGS. 2 and 3 provide an overview of the functioning of the inventive network 100. FIG. 2 is a diagram for collecting data utilizing the inventive network 100 according to an embodiment of the invention. As shown, data is collected by the web server 106 from the communication devices 110a-n over the communications network. The collected data can be geo-tagged or non-geo-tagged depending if a communication device is connected to a geo-aware source or not. The data collected by the web server 106 is then provided to the geo-server 102. The geo-server 102 converts the non-geo-tagged data to geo-tagged data 112 and provides to the database server 104 for storage.

FIG. 3 is a diagram for distributing data utilizing an inventive network 100 according to an embodiment of the invention. As shown, upon receiving a request for geo-tagged data 112 from the communications network geo-server retrieves stored geo-tagged data from the database server 104 and provides to the web server 106. The web server 106, in turn, provides the geo-tagged data 112 to the communication devices 110a-n over the communications network 118.

Geo-Server

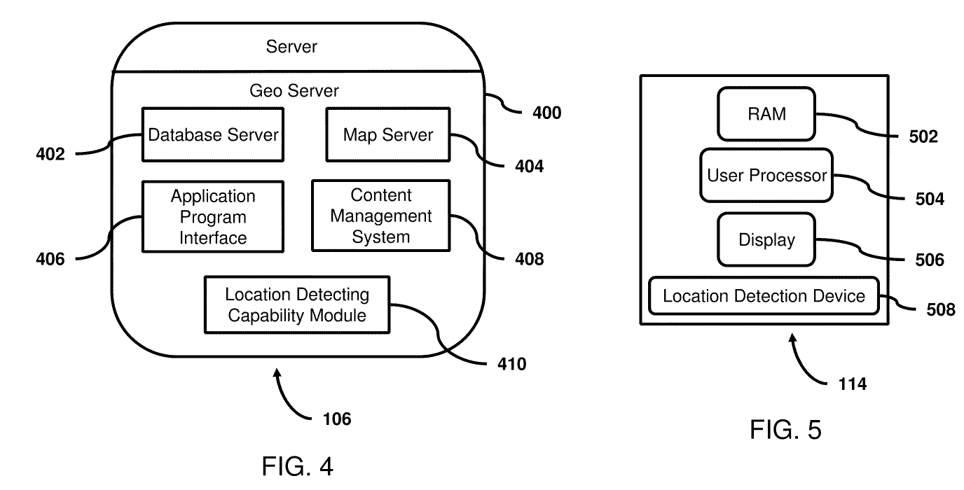

The geo-server 102 receives data collected from the communication devices 110a-n using the communications network 118, adds geo-tag to the received data if the received data is not geo-tagged, stores the geo-tagged data 112 and distributes the geo-tagged data 112 over the inventive network 100. In an embodiment, the geo-server 102 may communicate with a WCF server via a WCF-geo-server bridge for enabling service-oriented applications and/or extracting different data-types. The geo-server 102 may integrate with a third-party geo-input and/or geo-content database server 116, as shown in FIG. 1, over open protocols such as, Socket, HTTP/XML, JSON, etc. FIG. 4 is a diagram showing modules of the first server 106 according to an embodiment of the invention. As per this embodiment, the first server 106 includes the geo-server 102. Further, the geo-server 102 includes a database server 402, a map server 404, an application program interface (API) 406, and a content management system (CMS) 408. The API 406 may include a set of routines (executable software, code, or section of a program that performs a particular task), protocols (formats for transmitting data between devices), and tools for building, operating, running, and/or enabling the inventive network 100. The CMS 408 may allow for the adding, manipulation, and/or aggregation of the geo-tagged data 112. The inventive network 100 may integrate with and/or use known open protocols and/or file types thereby allowing the exchange and interoperability of data-types between systems including, but not limited to, GPX, RSS, KML, machine-readable language, microformats, iCal, XLS, PDF, JSON, XML and any other data-type chosen with sound judgment by a person of ordinary skill in the art. The inventive network 100 may also integrate with other known systems through API's thereby allowing third-party system information to be embedded, integrated with the inventive network 100. The geo-server 400 may further include a location detecting capability module 410 for providing location data to the network engine of the web-server 106.

Communication Devices

FIG. 5 is a diagram showing modules of a communication device 114 according to an embodiment of the invention. As per this embodiment, the communication devices 110a-n may each be suitable for implementing the inventive network 100 over the communications network 118. As shown in the FIG. 5, the communication device 114 includes a random access memory (RAM) 502, a user processor 504. In an embodiment, the user processor 504 may comprise a microprocessor suitable for executing a client application software stored in the RAM 502. The user processor 504 may be in communication with computer-readable media which stores instructions that, when executed by the user processor 504, cause the user processor 504 to perform the steps described herein. Examples of computer-readable media include, but are not limited to, an electronic, optical, magnetic, or other storage or transmission device capable of providing the user processor 504 of the communication devices 110a-n with computer-readable instructions. Further, the communication device 114 includes a display 506 in addition to various external or internal devices including, but not limited to, a mouse, a CD-ROM, DVD, a keyboard, and/or other input or output devices. Furthermore, in an embodiment, the communication device 114 may include or communicatively connected to a location detection device 508 which can provide information about the current location of the communication device 114.

In an embodiment, the location detecting capability module 410 may communicate with the location detection device 508 for determining the location of the communication devices 110a-n, so as to thereby infer the location of the users 110a-n. In an embodiment, the location detection device 508 may include an associated global navigation satellite system (GNSS) receiver, which utilizes navigation software to detect the location of the communication devices 110a-n based on the signals transmitted from GNSS transmitters, as is well known in the art. The location detecting capability module 410 may determine the location data via the communications network 118. In an embodiment, the location detecting capability module 410 may include equipment and/or software to determine location of the communication devices 110a-n by performing a process based on the strength of the data communication or other signals transmitted from the communication devices 110a-n and received at nearby wireless towers (not shown), as is well known in the art. Additionally, the location detecting capability module 410 may allow the users 110a-n to input or provide location data manually, by direct input, for example by entering (by speech, text, or bar-code or other machine readable data scanning, or any other method chosen with sound judgment by a person of ordinary skill in the art) location-identifying information, including, but not limited to, latitude and longitude, an intersection or venue name or other location-identifying information.

Mobile User Portal

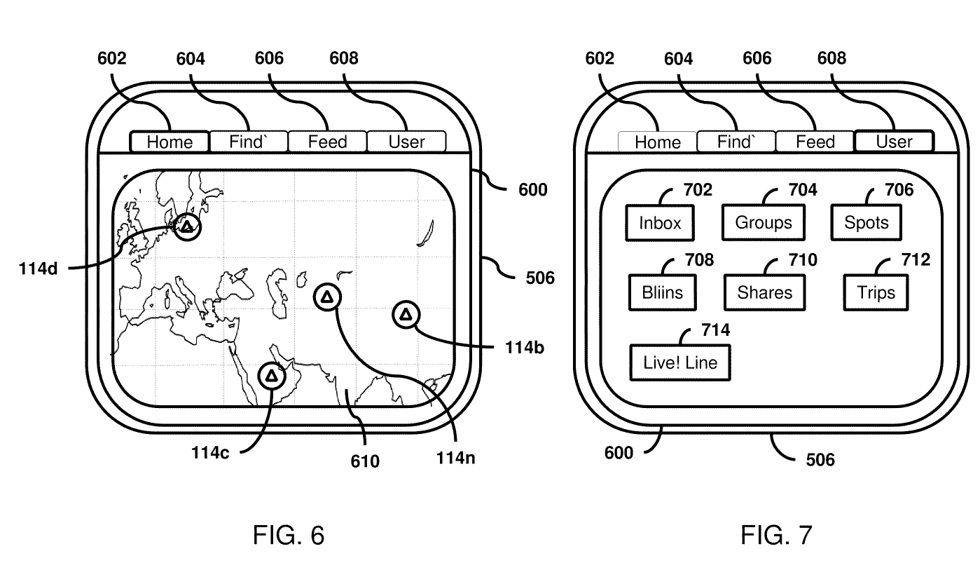

With reference now to the FIGS. 6 and 7, in an embodiment, the communication devices 110a-n may include a mobile user portal (MUP) 600 displayed on the display 506 of the communication devices 114a-n. The MUP 600 may include a mobile user interaction interface that allows for wireless voice and data communication over the communications network 118 including, but not limited to, a cellular or mobile phone, a smart phone, a digital assistant, a personal digital assistant, a pager, a digital tablet, a laptop computer, an Internet appliance, an on-board or integrated automobile communication system, and/or other electronic devices. The mobile user interaction interface can be rendered in an internet browser of the MUP 600. The MUP 600 may comprise a browser-based application having or utilizing a plurality of user tabs as shown in FIGS. 6 and 7.

FIG. 6 is a diagram showing a view of the MUP 600 according to an embodiment of the invention. As shown, the MUP 600 may comprise a home tab 602, a find tab 604, and a feed tab 606. In an embodiment, the MUP 600 may further include a user tab 608. The home tab 604 includes, as shown in FIG. 6, a map-based tab wherein the users 110a-n and geo-tagged data 112 are rendered on top of a map image 610. In an embodiment the map image 610 can be stored in the communication device 114. In another embodiment the map image 610 can be provided by the map server 120 or 404. In an embodiment, all viewable users 110a-n and geo-tagged data 112 may be displayed relative to the location of the individual user 110a wherein the users 110b-n and geo-tagged data 112 are displayed in distance-relation to the position of the user 110a. Further, the distance-relation may be measured in meters or a scaled quantity thereof. The find tab 604 may display the map image 610 in a 9×9 matrix of equally tiled images. Each of the individual tiles may be selected and zoomed in to thereby allowing the user 110a to move between a world view and the closest zoom view. The inventive network 100 may allow the user 110a to transmit location data to other users 110b-n. In an embodiment, the inventive network 100 may at least partially enable the transmission of location data by allowing the user 110a to selectively cause the client application software to access an integrated or associated communication application, including, but not limited to, short message service (SMS), email, instant message (IM), or any other communication application chosen with sound judgment by a person of ordinary skill in the art. For a non-limiting example, in an embodiment, the user 110a may transmit location data to other users 110b-n via short message service (SMS) by allowing the client software application to access an integrated SMS application. The body of the SMS may comprise a hyperlink that links the recipient, including those recipients who have not registered with the inventive network 100, to the inventive network 100 thereby allowing the recipient to view the current position of the user 110a. In an embodiment, recipients of the SMS click the link and are provided access to the find tab 604 with the user's 110a position centered on the map image 610. This feature allows the users 110a-n to transmit or send SMS visual location information to other users utilizing cellular phones.

FIG. 7 is a diagram showing another view of the MUP 600 according to an embodiment of the invention. As shown in FIG. 7, the user tab 608 may display various information and data relating to the user 110a-n including, but not limited to the user's inbox 702, groups 704, spots 706, bliins 708, shares 710, trips 712, live-line 714 or any other feature relating to or associated with the user 110a chosen with sound judgment by a person of ordinary skill that can be easily accessed and/or viewed by the user 110a.

Desktop User Portal

In an embodiment, the communication devices 110a-n may include a desktop user portal (DUP). The DUP, similar to MUP 600, may include a desktop user interaction interface such as, a desktop computer or other processor-based device that is generally constrained to a single location while the user 110a accesses the inventive network 100.

Users

The inventive network 100 may allow the users 110a-n to be either one of a live user or an idle user or a non-live user. A live user may comprise a user that has registered with the inventive network 100 and is automatically transmitting location data to the inventive network 100. An idle user can be registered with the inventive network 100 but not participating in the activities of the inventive network 100. A non-live user may comprise a user that has registered with the inventive network 100 and is not automatically transmitting location data to the inventive network 100 or a user that has not registered with the inventive network 100. Further, the inventive network 100 may allow users 110a-n to easily identify and differentiate between various users 110a-n by utilizing various methods including, but not limited to, a color system, a banner or other icon displayed in conjunction with the user. In an embodiment, the inventive network 100 may allow users 110a-n to easily identify and differentiate between users 110a-n by displaying the live user utilizing a green user icon and displaying the non-live user utilizing a blue user icon. Through a series of known technologies, the fluid movement of a live user can be depicted and a live user may be shown substantially fluidly animated on the map image 610. Additionally, the inventive network 100 may allow various attributes of the live user to be displayed on the map image 610 including, but not limited to, the live user's speed, direction, heading, destination, departure point, etc. Any changes in these attributes can be updated in near real-time on the map image 610, as per an embodiment. In another embodiment, changes in these attributes can be updated on the map image 610 based on changes in a set of pre-defined settings by users 110a-n which would trigger the update process. In an embodiment, the inventive network 100 may display the location of the non-live user as the non-live user's last known location. The term “users 110a-n” includes both live and non-live users unless otherwise specified. In instances in which differences apply, the users 110a-n will be differentiated as live users 110a-n and non-live users 110a-n.

Now, the user 110a may utilize the communication device 114a to access the inventive network 100 via the communications network 118. Accessing the inventive network 100 may cause a map image 610 to be displayed on the display 506. In an embodiment, the map server 404 may store the map images 610 that are displayed on the display 506 of the communication device 114a. In an embodiment, the map images 610 include a plurality of individual image files of maps with varying degrees of granularity. For example, an image of a specific country may include a plurality of images that allow the user 110a to zoom in to display the map image of a state, city, street, or building located within that country. The map image 610 may comprise layers of data, both geo-tagged data 112 and non-geo-tagged data that can be displayed over individual image files. The layers of data may allow for the display of a wide range of information and/or data including, but not limited to, weather information; radiation data; UV-exposure data; traffic data; transportation networks such as, for a non-limiting example, rail, bus, highway, sea and/or air; services, such as, for a non-limiting example, hotels, restaurants, shopping, and/or tourist attractions; and/or points of interest or other data, provided by the users 110a-n.

Accessing the Inventive Network

In an embodiment, accessing the inventive network 100 may cause the network engine to cause an information request to be outputted and displayed over the map image 610. The information request may allow the user 110a to initiate a registration process, to initiate a log-on process, or to initiate a viewer process. The user 110a may initiate a process by utilizing the communication device 114a to actuate a button, hyperlink, menu selection, or other selection feature chosen with sound judgment by a person of ordinary skill in the art. In an embodiment, the information request may comprise an interface window that allows the user 110a to initiate the registration process by utilizing a mouse, keyboard, pointer, or other input device associated with the communication device 114a to select a registration hyperlink. The selection of the registration hyperlink may cause a pop-up form to be displayed that allows the user 110a to input various identifying data. In another embodiment, the selection of the registration hyperlink may cause a the user 110a to be directed to a webpage, an electronic mail form, a printed form, or other suitable process chosen with sound judgment by a person of ordinary skill in the art, that allows the user 110a to input the identifying data. The registration process may be initiated by the user 110a utilizing any method chosen with sound judgment by a person of ordinary skill in the art. The pop-up form may include a plurality of text input fields that allow the user 110a to create a user name, password, and provide an email address for receiving electronic messages. Additionally, the user 110a may be required to input an initial bookmark. The initial bookmark may comprise location data indicating the current location of the user 110a or a location of interest selected by the user 110a. Upon successful registration, the user 110a may be required to download a client application software that may be stored in the memory of the communication device 114a. The client application software may comprise a client-side network engine for communicating with or accessing executable programs stored on the network engine of the web server 106, herein after referred to as main network engine. Alternatively, the user 110a may be required to download the client application software prior to registering. A registered user 110a-n may refer to a user who has successfully completed the registration process mentioned.

Now, the user 110a may initiate the log-on process by utilizing a mouse, keyboard, pointer, or other input device associated with the communication device 114a to select a log-on hyperlink. The selection of the log-on hyperlink may cause a pop-up form to be displayed that allows the user 110a to input their username and password or other identifying information. The main network engine may verify that the user 110a entered the correct identifying information, for example, the password entered is the password that is associated with the username entered, prior to allowing the user 110a to access the inventive network 100 as a registered user. Upon verification of the identifying information, the main network engine may require the registered user 110a to determine the user's mode of transmitting location data to the inventive network 100. In an embodiment, the main network engine may communicate with the client-side network engine to determine the availability of location detecting capability module 410. If location detecting capability module 410 is determined to be available, the main network engine may allow the registered user 110a to select an automatic location mode, thereby allowing the user 110a to utilize the inventive network 100 as a live user, by selecting the available location detecting capability module 410. If no location detecting capability module 410 is determined to be available, the main network engine may require the registered user 110a to select or operate in a manual location mode, thereby causing the user 110a to utilize the inventive network 100 as a non-live user. Further, the selection of the automatic location mode may cause the client application software to automatically update the location of the user 110a. The selection of the manual location mode may cause the main network engine to utilize a default bookmark and require the user 110a to manually input current location information. In an embodiment, the default bookmark may include the initial bookmark. In another embodiment, the default bookmark may include the most recently entered location of the user 110a. The default bookmark may include any location chosen with sound judgment by a person of ordinary skill in the art.

A viewer may be a user who has not successfully completed either the registration process, i.e. a non-registered user, or the log-on process. The inventive network 100 may allow the viewer to view, browse, or otherwise interact with at least a portion of the geo-tagged data 112 contained within the inventive network 100. In an embodiment, the inventive network 100 may allow the viewer to view, browse, or otherwise interact with the geo-tagged data 112 that a registered user 110a-n has designated as being accessible to the public or any user 110a-n as more fully described below. The inventive network 100 may allow the viewer to interact or communicate with other viewers and/or registered users 110a-n. The inventive network 100 may allow the viewer to communicate with other viewers and/or registered users 110a-n via SMS to follow registered users 110a-n that have a public visibility setting as described below, to conduct searches within the inventive network 100 as well as any other feature chosen with sound judgment by a person of ordinary skill in the art. The inventive network 100 may include various features that may only be accessed or operated by registered users 110a-n. In an embodiment, the inventive network 100 may allow a user to access the inventive network 100 as a viewer by initiating a viewer process. The viewer process may be initiated by utilizing a mouse, keyboard, pointer, or other input device associated with the communication device 114a to select a viewer hyperlink.

User Profiles/User IDs

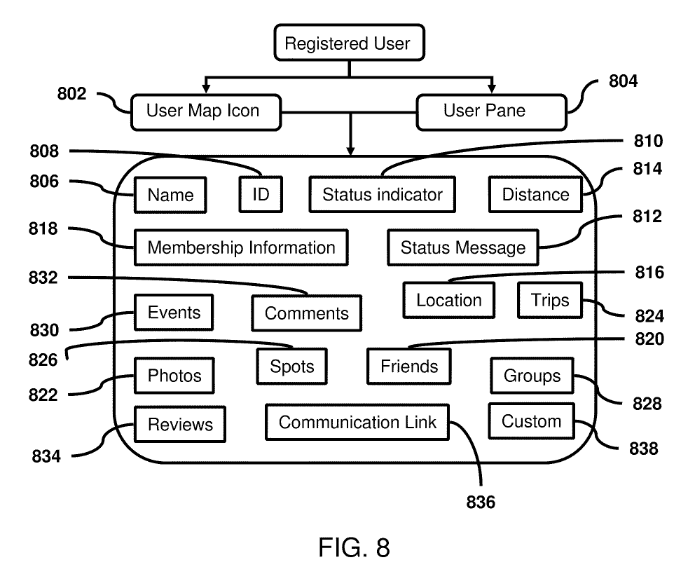

The main network engine may cause a user profile to be associated with each registered user 110a-n. The user profile may be available amongst the users 110a-n thereby allowing the inventive network 100 to include a location based social networking utility. The user profile may include a user map icon 802 and/or a user pane 804, as shown in FIG. 8. FIG. 8 is a diagram showing options available to a user of the inventive network according to an embodiment of the invention. The user map icon 802 may comprise a selectable or a floating icon that is displayed over the map image 610 and is continuously associated with the location of the user 110a-n. The user pane 804 may comprise an image pane that is statically displayed on the display 506. For example, the user pane 804 may be continuously located along the leftmost edge of the display 506. In an embodiment, the user pane 804 may be selectively positioned by the user 110a-n. The user map icon 802 and the user pane 804 may comprise various information relating to the user 110a-n, as shown in FIG. 8.

Further, the main network engine may cause a user ID to be associated with each registered user 110a-n. The user ID may be coupled to the user profiles including, but not limited to: names, birthdays, gender, education, profession, marital status and any other information chosen with sound judgment by a person of ordinary skill in the art.

User Panes

With reference now to the FIG. 8, the user pane 804 and/or the user map icon 802 may comprise information and media relating to the user 110a-n. The user pane 804 and/or the user map icon 802 may list various items of user information that may be determined by the user 110a-n or may comprise a list of predetermined fields that are supplied from data obtained during the registration process. In an embodiment, the user pane 804 and/or the user map icon 802 may provide information relating to the user 110a that may be viewed by the user 110a and/or other users user 110b-n. The information provided by the user pane 804 and/or user map icon 802 may include, but is not limited to, the user name 806 or user ID 808 of the user 110a; a user status indicator 810 that may visually indicate, for a non-limiting example, through the use of a user pane color scheme, the current status of the user 110a as either live user 110a, non-live user 110a, or a viewer; a status message 812 that may include text message to indicate the current status of the user 110a; a distance notification 814, a user location 816, a membership information 818, a list of friends 820 that may indicate the number of friends associated with the user 110a, or may indicate the number of friends associated with the user 110a that are currently logged-in to the inventive network 100; a photos number 822 that may indicate the number of photos uploaded, saved, and/or otherwise accessed by the user; a trips number 824 that may indicate the number of trips recorded by the user 110a; a spots number that may indicate the number of spots uploaded, saved, and/or otherwise accessed by the user 110a; a groups number 828 that may indicate the number of groups the user 110a is associated with or belongs to, an events number 830, a comments number 832, a reviews number 834, or any other custom information 838 chosen with sound judgment by a person of ordinary skill in the art. Additionally, the user pane 804 and/or the user map icon 802 may provide a link for communicating with the user 110a that can be accessed by other users 110b-n. The user pane 804 and/or user map icon 802 may display the preferred or popular shares or spots or other geo-tagged data 112 relating to the user 110a.

Map Display

The map image 610 may comprise an interactive map setting and a static map setting. In an embodiment, the interactive map setting may display the near real-time location of the users 110a-n. The static map setting may display the location of the users 110a-n at a specific moment in time. The main network engine may allow the user 110a to selectively determine the specific moment by date, time, and/or location. In an embodiment, the specific moment may be at least partially determined as a function of the selection of the static map setting. In an embodiment, the main network engine may allow the user 110a to toggle between the interactive map setting and the static map setting.

In an embodiment, the users 110a-n may designate personal, customized maps as a base layer of their user interaction interface. The customized maps may replace traditional map imagery. Further, the customized maps may include a joint photographic experts group (JPEG/JPG), graphics interchange format (GIF), portable network graphics (PNG), or other type of image file chosen with sound judgment by a person of ordinary skill in the art that is processed and output to the communication device 110a-n similar to the map image 610.

Live-Line Feature

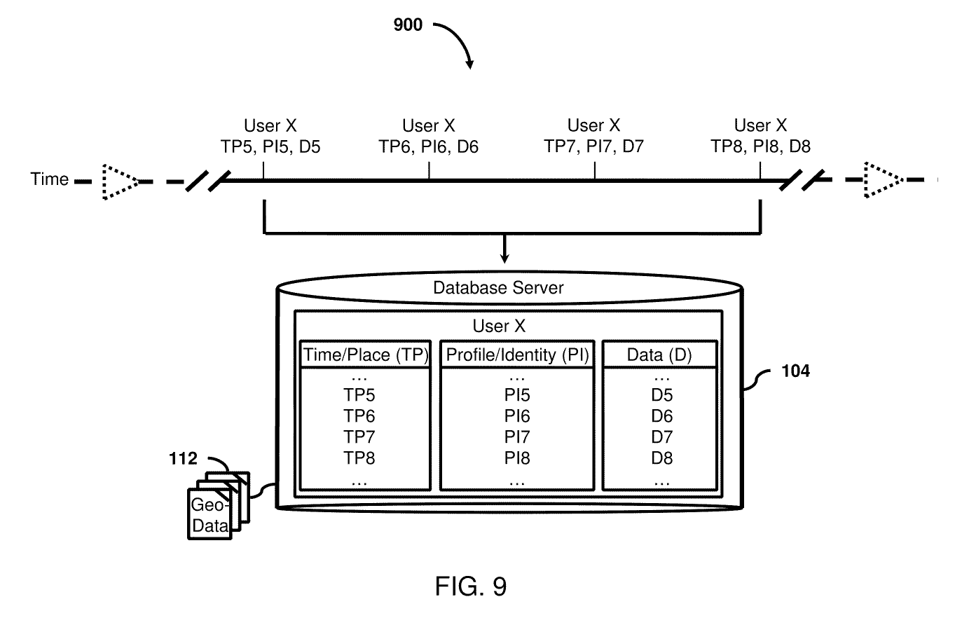

With reference now to the FIG. 9, the inventive network 100 may allow the users 110a-n to create a live-line 900. The live-line 900 may comprise a substantially real-time geo-data stream that begins upon registration by the user 110a-n to the inventive network 100 and ends at the last log-on to the inventive network 100 by the user 110a-n. The live-line 900 may be recorded and saved in the database server 104 and can be played or viewed by the users 110a-n. The live-line 900 may comprise a plurality of changing variables such as, time, place, user profile, user identity, and geo-tagged data 112. The live-line 900 may comprise any variable chosen with sound judgment by a person of ordinary skill in the art.

Further, the live-line 900 may at least partially enable tagging of media uploaded to the inventive network 100. In an embodiment, the main network engine may cause an uploaded file to be analyzed in order to determine the time and/or date the file was created and tag the file with the time/date before storing in the database server 104. Further, the time and/or date the file was created may be determined by analyzing the file's metadata. The main network engine may then cause the time and/or date determined from the file's metadata to be compared to the live-line 900 of the user 110a to determine the user's location at that time and/or date. The determined time and/or date may then be combined with the determined location to geo-tag the uploaded file.

Time/Place Variable

With reference now to the FIG. 9, in an embodiment, as the user 110a registers and logs-on to the inventive network 100, the inventive network 100 may capture time-place (TP) data relating to the user 110a. The inventive network 100 may capture the time-place data 33 through a series of methods well known in the art. In an embodiment, the time-place data may include a Universal Time (Universal Time Code) and Place stamp (location: longitude, latitude, altitude). The main network engine may store the time-place data in the database server 104. Periodically, the main network engine may cause new or additional time-place data relating to the user 110a to be captured and collectively stored in the database server 104. The collective storing of the time-place data of the user 110a may allow the inventive network 100 to generate a Time/Place live-line for the user 110a which may then be published on the map image 610 to the user 110a and/or other users 110b-n.

Profile/Identity Variable

With reference to the FIG. 9, in an embodiment, upon or during registration, the user 110a may submit a series of static Profile and Identity (PI) data, to the inventive network 100. The PI data may include, but is not limited to, the name, birthday, gender, and/or address of the user 110a and the college, high school, and/or university attended by the user 110a. The PI data may include any type of data chosen with sound judgment by a person of ordinary skill in the art. The PI data may be stored in the database server 104. Over time, the inventive network 100 may capture additional PI data of the user 110a, including, but not limited to, visited places, vicinity, other users, viewing preferences, or other information chosen with sound judgment by a person of ordinary skill in the art. Now, the PI data can be shown over the communications network 118 to the user 110a and/or other users 110b-n, thereby enabling network services including but not limited to social networking, matchmaking, supplying location/profile relevant advertising, and/or any other service chosen with sound judgment by a person of ordinary skill in the art.

Geo-Data/Shares Variable

With reference to the FIG. 9, the inventive network 100 may allow the user 110a to upload/stream data, both geo-tagged data 112 and non-geo-tagged data subsequently converted to geo-tagged data 112 by the inventive network 100, on the inventive network 100. The uploaded/streamed data may include, not limiting to, photos, videos, audio, text, etc., to which the main network engine may cause a time, place stamp and a geo-tag to be associated with and then stored in the database server 104. The main network engine may utilize the uploaded/streamed geo-tagged data 112 to be captured in live-line 900 of the user 110a which may then be published on the map image 610 to the user 110a and/or other users 110b-n for enabling services including but not limited to, social networking, archiving, and/or any other service chosen with sound judgment by a person of ordinary skill in the art.

RADAR Feature

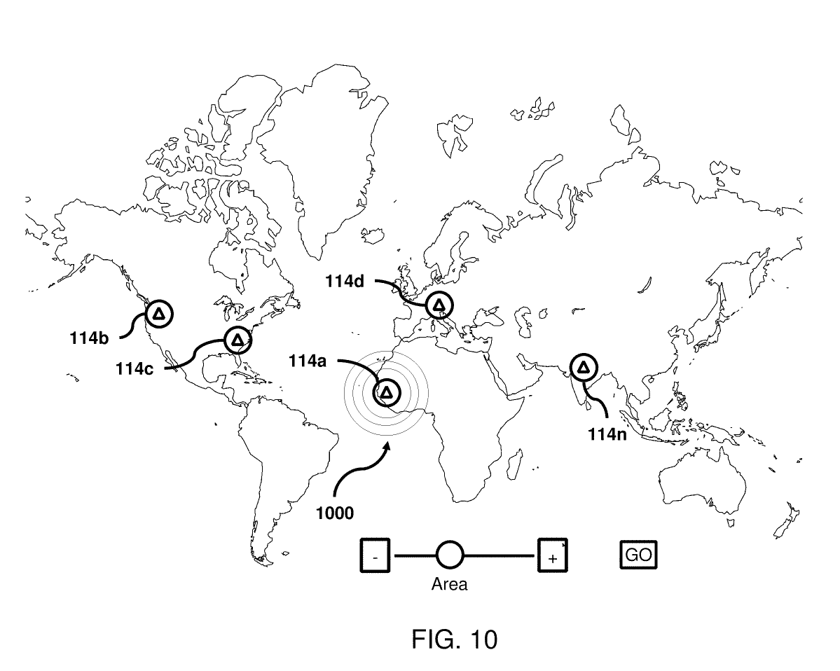

With reference now to the FIG. 10, the inventive network 100 may comprise a radar 1000. In an embodiment, the radar 1000 may utilize a plurality of circles and/or dots displayed over the map image 610. The user 110a may be represented by a dot displayed over the map image 610 to represent the current location of the user 110a that is centered within a circle representing an area of interest around the user 110a, as shown in FIG. 10. Further, other users 110b-n and/or geo-tagged data 112 may be represented with other dots displayed on the map image 610. The inventive network 100 may utilize any method and/or symbols for representing and differentiating users 110a-n and/or geo-tagged data 112 chosen with sound judgment by a person of ordinary skill in the art. Further, the inventive network 100 may allow the user 110a to selectively determine the radius of the circle thereby allowing the user 110a to selectively adjust the size of the area of interest. In one of the embodiment the radius of the circle of interest can be determined using a slider, as shown in FIG. 10.

User Trace Feature

In an embodiment, the map image 610 may further include a selectable user trace icon for controlling the display of a user trace over time. For example, in an embodiment, the main network engine may allow the user 110a to determine a specific time duration or range for which data is displayed on the map image 610. Using the user trace feature the user 110a can “look back in time” by showing only the data uploaded on, prior to, or after a particular time and/or date specified by the user 110a.

Friends

The main network engine may allow each user 110a-n to designate other users as a friend. In an embodiment, designating another user as a friend may automatically grant the ‘friend’ user special rights and/or visualization methods within the inventive network 100, chosen with sound judgment by a person of ordinary skill in the art. In another embodiment, the ‘friend’ user can view geo-tagged data 112, user ID or profile information, or other features chosen with sound judgment by a person of ordinary skill in the art as predetermined by the friend-designating user 110a. In yet another embodiment, the users 110a-n will have to decide upon the access rights of the ‘friend’ user immediately after the ‘friend’ user is designated as a friend.

User Communication

The inventive network 100 may allow communication between users 110a-n, viewers, and any other device, person, animal, or object accessing the inventive network 100. The inventive network 100 may allow the users 110a-n to send or transmit personal messages between each other. The inventive network 100 may further allow the users 110a-n to combine a series of individual personal messages in form of a conversation. In an embodiment, the individual personal messages comprising the conversation may include personal messages transmitted or communicated between users 110a and 110b. In another embodiment, the individual personal messages comprising the conversation may include personal messages transmitted or communicated between multiple users 110b-n and the user 110a. In yet another embodiment, the individual personal messages comprising the conversation may include personal messages transmitted or communicated between multiple groups of multiple users 110a-n. The conversation may comprise any number of personal messages communicated between users 110a-n, viewers, device, animal, or any other person or object accessing the inventive network 100. Additionally, the inventive network 100 may allow the users 110a-n to post personal messages and/or conversations with respect to the geo-tagged data 112. In an embodiment, the main network engine may cause a personal message or conversation that is posted with respect to the geo-tagged data 112 to be published to the user 110a who originally published the geo-tagged data 112 and/or the users 110b-n who have previously posted personal messages or conversations to the geo-tagged data 112.

Alerts

In an embodiment, the inventive network 100 may allow the users 110a-n to set an alert. The alert may include an audio and/or visual notification that is transmitted to the communication device 114a-n of the user 110a-n upon the occurrence of a particular event, as per the settings by the user 110a-n, within the inventive network 100. The alert can be custom set to transmit a notification to the user 110a-n upon the occurrence of geographic events (geo-fencing), user profile events (geo-matching), posting events (geo-posting), and/or any other event chosen with sound judgment by a person of ordinary skill in the art. In an embodiment, any notification, alert, or other communication transmitted to the users 110a-n may be received into the inbox 702 of each of the users 110a-n. The inbox 702 may include a personal communication module that receives, stores, and allows the user 110a-n access to communication transmitted by the other users.

Trips

The inventive network 100 may allow the users 110a-n to create a trip. For this, the users 110a-n may be required to automatically transmit location data, or be a live user, prior to create the trip. The trip may include a particular continuous period of time and/or locations selected by the user 110a-n. The trip may comprise the route traveled by the user 110a-n during a particular period of time. In an embodiment, the trip may comprise a particular period of time and/or location of the user's 110a-n or which the users 110a-n were or are live. The trip may comprise a plurality of trip positions that are recorded and stored on the database server 104. The trip positions may include a set of discrete locations visited by the user 110a-n. The trip may be played back on the map image 610. In an embodiment, the trip may be displayed on the map image 610 utilizing an identifying means, such as, for one non-limiting example, an orange colored icon that allows the trip to be easily identified as a trip by the users 110a-n. The trip may include various data specifications including, but not limited to, distance, time, speeds, average speed, max speed, idle time, etc. of the users 110a-n. The various data specifications may be graphically displayed on the map image 610. Data uploaded and tagged to the trip may be displayed while the trip is being viewed or may be selected and individually viewed by the users 110a-n. The inventive network 100 may allow the user 110a-n to pause or stop the recording of a particular trip and then continue the trip at a later time. The user 110a-n may upload data during and/or after completing the trip via their communication device 110a-n. The trip may be tagged by the user 110a-n and may comprise a visibility setting applicable to the trip as a whole as well as visibility settings applicable to each of the uploaded data, individually.

Bookmarks Feature

The inventive network 100 may allow the users 110a-n to create a bookmark. The bookmark may include a user-selected location (longitude, latitude) on the map image 610 that the users 110a-n can name and save. This allows the users 110a-n to access the bookmark directly at a later time. In an embodiment, the users 110a-n may visit the bookmark by selecting the bookmark from a user-created list of bookmarks. The selection of the bookmark can cause the inventive network 100 to position-render the user 110a-n on the map image 610 corresponding to the bookmark.

Bliins

The inventive network 100 may allow the users 110a-n to create a bliin. The bliin may include a personal collection of filters on the geo-tagged data 112 that monitors changes or alterations in the collection of filters. The users 110a-n may create, save, share and/or monitor the bliin. In an embodiment, the users 110a-n may receive a notification or alert when the inventive network 100 determines that the bliin has been affected. In an embodiment, the notification may comprise a standard text email message sent to the users 110a-n. In another embodiment, the notification may be transmitted or sent via SMS, email, MMS, inbox message, or utilizing any other communication means chosen with sound judgment by a person of ordinary skill in the art. In an embodiment, the user 110a may initiate or start a bliin by selecting an associated location that will comprise the center point of a circle that represents the user's location or area of interest for monitoring changes or alterations in the collection of filters. The user 110a may set the bliin to monitor the geo-tagged data 112, other users 110b-n, or both within the user's area of interest. In an embodiment, creating the bliin may allow the user 110a to determine the criteria or user-events sought to be monitored. The user-events may include, but are not limited to, users 110a-n arriving or departing a specific location or area; users 110a-n uploading and/or publishing data related to a particular theme, category, user, or other event, or any other user-event chosen with sound judgment by a person of ordinary skill in the art.

Spots

The inventive network 100 may allow the users 110a-n to create a spot which can include a location on the map image 610. The spot may include a name, a description, and/or a category for identifying, grouping, or sorting the spot. The spot may be customized by the user 110a-n by associating an image or other share with the spot. The inventive network 100 may allow the users 110a-n to create, save, join and post in the spot. The spot may comprise user-created settings relating to: who can access the spot, join or be associated with the spot, post comments with respect to the spot, thereby allowing the user 110a-n to determine the respective characteristics for the spot. Further, the spot can be accessed by multiple users at the same time.

Groups

With reference now to the FigureS, the inventive network 100 may allow the users 110a-n to create a group. The group may comprise a collection of users 110a-n, geo-tagged data 112, trips, and/or any other communication, including, but not limited to, personal messages, or conversations between the users 110a-n. The inventive network 100 may allow the users 110a-n to create, save, join, and/or post in the group. The group may include a selectable icon that allows the users 110a-n to view, access, or otherwise communicate with geo-tagged data 112 or other users associated with the group. The inventive network 100 may allow the group to comprise various identifying indicia including, but not limited to a name, description, geo-tagged data 112, and/or information chosen with sound judgment by a person of ordinary skill in the art.

Albums

The inventive network 100 may allow the users 110a-n to create an album. The album may include a selectively arranged collection of geo-tagged data 112, stored on the database server 104. The inventive network 100 may allow the users 110a-n to create, save, view, or post comments to the album. Further, the album may include geo-tagged data 112 that is uploaded by the user 110a or by other users 110b-n. The inventive network 100 may allow the users 110a-n to create albums within spots and groups.

Quests

The inventive network 100 may comprise a quest feature. The quest may comprise a user-created marker-location displayed on the map image 610 that contains a task for another user or users who choose to take on or attempt to complete the quest. A user 110a-n who attempts to complete the task may be awarded with a score upon successfully completing the quest. The value and/or success-factor of a particular quest may be determined by the creating user or amongst a group of users. The inventive network 100 may allow the quest to comprise various identifying indicia including, but not limited to a name, description, geo-tagged data 112, and/or information chosen with sound judgment by a person of ordinary skill in the art.

Visibility Settings

The inventive network 100 may comprise a visibility setting that allows the users 110a-n to control the level of security or privacy associated with a particular data or feature. The visibility settings may comprise a plurality of settings or levels that function to control the users' 110a-n access to the uploaded data or features. In an embodiment, the visibility settings may comprise a private mode, a friend mode, and a public mode. In the private mode the user 110a and associated data or feature may be visible only to the user 110a. In the friend mode the user 110a and associated data or feature may be visible only to the users 110b-n designated as Friends of the user 110a. In the public mode, the user 110a and associated data or feature may be visible to any user accessing the inventive network 100.

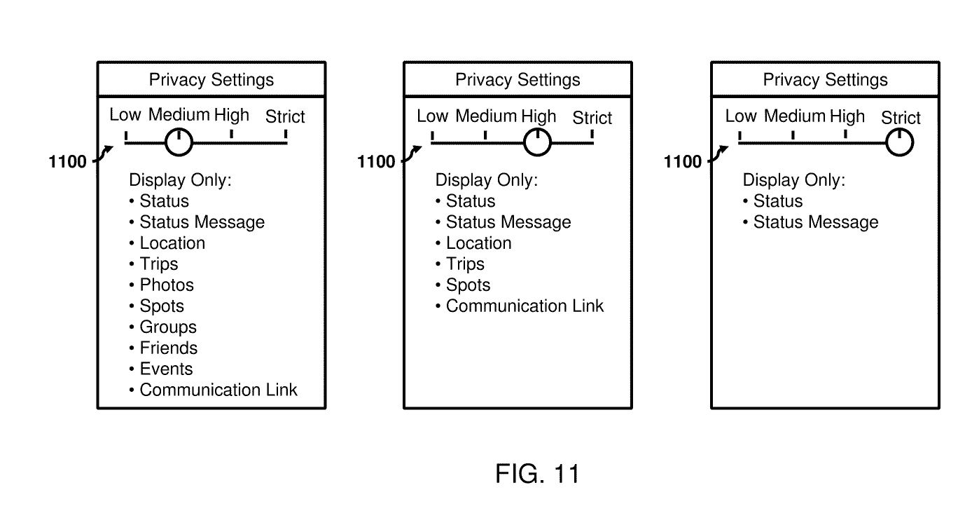

With reference now to the FIG. 11, the inventive network 100 may allow the users 110a-n to control the visibility settings utilizing a nimity slider 1100. The nimity slider 1100 may provide the users 110a-n with an automatically generated levels of privacy. The nimity slider 1100 may automatically adjust the users' 110a-n visibility settings based on a number of predetermined user preferences or selections combined with computer learning/smart algorithms. The nimity slider 1100 may utilize computer learning/smart algorithms that monitor and analyze various aspects of user data including, but not limited to, the users' 110a-n access of the inventive network 100, trip patterns, user-determined visibility settings, locations visited, types of geo-tagged data 112 that the user uploads, views, or otherwise interacts with, and any other type of user data chosen with sound judgment by a person of ordinary skill in the art. In an embodiment, the nimity slider 1100 may adjust the users' 110a-n visibility settings by adjusting the fields displayed associated with or published by the user. As shown in the FIG. 11, the number of fields displayed decrease when the nimity slider moves from medium to strict privacy settings. Hence, a user can trust the system to best comply with privacy wishes without the bother of manually setting it each time and instance.

Collections

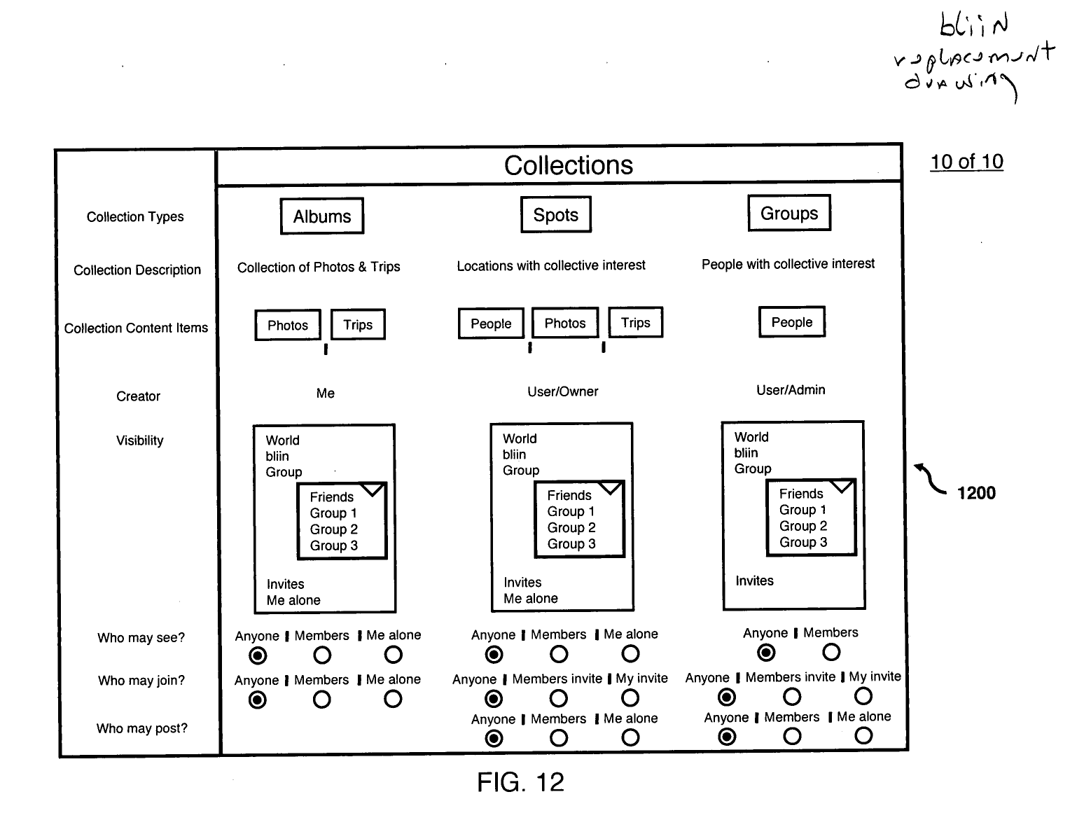

With reference now to the FIG. 12, the inventive network 100 may allow the users 110a-n to create collections 1200. In an embodiment, the inventive network 100 may allow the users 110a-n to create an album collection, a spots collection, and a groups collection. The albums collection may be created by an individual user 110a and may comprise a collection of photos and trips. The user 110a may determine the visibility setting that applies to the album collection as a whole and may also determine the visibility setting of individual photos and/or trips comprising the album collection. The visibility setting for the album collection may determine which users 110b-n may view and/or post comments to the album collection and/or individual photos and/or trips contained therein. The user 110a creating the album collection may be the only user allowed to upload shares to the album collection or invite other users 110b-n to view and/or post to the album collection.

Further, the spots collection may comprise a collection of data that relate to one or more locations pertaining to a particular interest. The spots collection may be created by an individual user 110a and may include a collection of users 110a-n, photos and trips. The user 110a-n creating the spots collection may be referred to as the owner user 110a. The owner user 110a may determine the visibility setting that applies to the spots collection. The visibility setting for the spots collection may determine which users 110b-n may view, post comments, upload data and/or invite other users 110a-n to join the spots collection. Other users 110b-n uploading data to the spots album may determine the visibility setting for their uploaded data for the other member users 110a-n of the spots collection.

The groups collection may comprise a collection of data that relate to individual users 110a-n having a similar or collective interest, such as photography, adventure sports and politics. The group collection may facilitate the communication and interaction of the users 110a-n that are members of the group collection.

Shares

A share includes data uploaded by the user 110a-n to the inventive network 100, that can be stored in the database server 104. The share may include any type of geo-tagged data 112 or non-geo-tagged data including, but not limited to, a text file, a personal message or a conversation; a video file, an audio file, a picture or photo, and/or any combination thereof. In an embodiment, the inventive network 100 may comprise an auto-media-share upload feature to allow the users 110a-n to configure their communication device 110a-n to automatically transmit or upload the share to the inventive network 100 substantially instantly after acquiring the share. The inventive network 100 may allow the user 110a-n to fix various attributes and/or features associated with the share including, but not limited to, designating a particular collection type, including but not limited to, an album, spot, or group collection and/or the privacy level or visibility setting thereby allowing the share to be uploaded in accordance with the user's specified criteria or settings without requiring any user intervention. The CMS 408 may allow the users 110a-n to manipulate or alter the uploaded shares including, but not limited to, allowing users 110a-n to edit, upload, alter and/or customize the shares. In an embodiment, the users 110a-n may be allowed to modify and/or review all viewable content, including, but not limited to, the geo-tagged data 112 and the shares, within the inventive network 100. The modifying and reviewing of viewable content may include, but is not limited to, deleting if the user is the owner or publisher of the content, editing, flagging as inappropriate, rating, or reviewing the viewable content.

Further, the users 110a-n may incorporate additional shares with one or more previously uploaded shares. The share may be geo-tagged by the user 110a-n and may include a visibility setting defined by the users 110a-n. Selection of a particular type of share in the menu provided by the MUP 600 may cause the particular communication device 114a-n to be activated. For example, the MUP 600 may provide an icon for allowing the user to select a picture share. The selection of the icon may cause the MUP 600 to cause a camera integrated into the communication device 114a-n to be activated thereby allowing the user 110a-n to take a picture. The MUP 600 may allow the user 110a-n to upload and post the digitally captured share which is then stored in the database server 402 and published on to the map image 610 to correspond with the location of capture. The inventive network 100 may cause a share to be published to a user 110a wherein the share is positioned on the map image 610 displayed on the display 506 of the communication device 114a. The inventive network 100 may cause a share to be published to the user 110a based on the current location of the user 110a and/or predetermined preferences. The predetermined preferences may be selected by the user 110a or may be determined by the inventive network 100 based on the user's past accessing of the inventive network 100.

In an embodiment, the share may be substantially uploaded to the inventive network 100 with only a predetermined set of identifying information. The inventive network 100 may allow the users 110a-n to update, add, delete or otherwise modify the share or its identifying information at some time after the share has been uploaded and/or published. The share may be visible to the uploading or publishing user 110a-n until the user 110a-n performs a specific task required by the inventive network 100 including, but not limited to, determining the visibility setting for the share, providing identifying information for the share, including but not limited to, name, category, and/or group, or any other task that requires the user 110a-n to perform an affirmative act to acknowledge the uploading and/or publishing of the share.

Widgets

The inventive network 100 may allow the users 110a-n to create a widget. The widget can be a mini application that can be embedded in websites outside the inventive network 100. The widget may show a user's current location, posts, traces, or other share or information uploaded to the inventive network 100. In an embodiment, the widget may include a sidebar format and/or a top-window format.

Tiles

The inventive network 100 may include a tiles feature. In an embodiment, the tiles feature may be accessed via the find tab 604 and may allow the user 110a to “tile” a set of search results, i.e. to view a mini thumbnails of all the users 110b-n and/or shares in a location near or adjacent to the user 110a. The tile feature 140 may provide the user 110a with a bird's eye view or general overview of user-events occurring around the user 110a via the tiles or mini pictures. The tiles feature may allow the user 110a to ‘page back’ in time thereby allowing the user 110a to view past user-events that may have occurred weeks and/or months earlier. The tiles feature may also allow the user 110a to tile the results of a specific search. In an embodiment, for example, the user 110a may conduct a search for a particular type of restaurant, such as, for example, an Italian restaurant, located within a predetermined distance of the user 110a. The tiles feature may cause the results returned from the conducted user-search to create an overview in the form a thumbnail view of all the shares matching the inputted query. In an embodiment, each thumbnail image or tile may comprise a hyperlink to the item detail page associated with that thumbnail.

RSS Feature

The inventive network 100 may allow to publish geo-RSS, that may included, but is not limited to, RSS that is associated with a geographic location and/or geo-tagged data 112, that the users 110a-n and/or viewers can subscribe to in RSS readers. The inventive network 100 may allow the users 110a-n to capture the geo-RSS and incorporate it in an external website to at least partially accommodate updates and content monitoring by the user 110a-n.

Location Driven Advertising/Searching

The inventive network 100 may allow for location driven advertising or searching where the advertisements or search results provided to the users 110a-n are at least partially provided as a result relative to the current location of the users 110a-n, as per an embodiment. The results may be supplied as a result of a specific query performed by the users 110a-n or may be automatically sent or pushed to the users 110a-n based on the current location of the user 110a-n and/or a list of user determined preferences. In an embodiment, a search field can be provided to the users 110a-n. The search field may include a pull-down list of distance choices, such as anywhere, near me, very near me, and in current view. Selection of anywhere may cause the main network engine to provide a listing of results that is not geographically limited. Selection of near me may cause the main network engine to provide a listing of results that is limited by a first distance D1. Selection of very near me may cause the main network engine to provide a listing of results that is limited by a second distance D2 that is less than the first distance D1. Selection of current view may cause the main network engine to provide a listing of results that is geographically limited by the geographic area currently displayed on the display 506 of the communication device 114a of the user 110a. The first and second distances D1, D2 may be defined as a predetermined distance from the current location of the user 110a or a location specified by the user 110a. In an embodiment, the main network engine geographically limits the listing of results by providing results that relate to items or locations within a circle whose center substantially corresponds to the current location of the user 110a and whose radius substantially equals the first or second distance D1, D2.

Sub-Networks

The inventive network 100 may enable the creation and operation of a plurality of independent sub-networks within the inventive network 100. The sub-networks may comprise an open sub-network that may generally be open to all users 110a-n or a closed sub-network that is limited to a select or predetermined group of users. The closed sub-network may limit the group of users utilizing various criteria including, but not limited to, by the number of users, by the type of user, or by users located within a predetermined geographic area. In an embodiment, a user 110a-n may determine the criteria used for limiting the closed sub-network. In an embodiment, the closed sub-network may be user-static wherein the group of users associated with the closed sub-network can not be changed. Alternatively, in another embodiment, the closed sub-network may be dynamic wherein the group of users associated with the closed sub-network can change based on a predetermined criteria including, but not limited to, being located within a particular geographic location, being associated with a particular group or spot, being associated with a particular organization, or any other criteria chosen with sound judgment by a person of ordinary skill in the art. In an embodiment, the sub-network may interact with other users 110a-n and/or other sub-networks. The sub-network may interact with other users 110a-n and/or other sub-networks similar to an individual user 110a in a manner including, but not limited to, sending or transmitting communications or messages to other users 110a-n; posting or publishing geo-tagged data 112 and/or non-geo-tagged data, creating trips, creating a live-line 900, or any other feature accessible by the individual users 110a-n chosen with sound judgment by a person of ordinary skill in the art.

Further, the inventive network 100 may allow an administrator to be associated with one or more of the sub-networks. The administrator may include a user 110a having specific rights and authorizations with respect to the associated sub-networks. In an embodiment, the administrator may establish the closed sub-networks at least in part by determining the users 110a-n visibility and can interact and/or communicate within the closed sub-networks. The inventive network 100 may allow the administrator to customize, alter, or modify the associated sub-networks to allow the associated sub-networks to meet the specific functionality and styling demands of the administrator thereby increasing one or more desired attributes including, but not limited to, types of communication, ease of communication, rules, and/or authorizations specific to the group of users comprising the sub-network. The CMS 408 may allow the administrator to create, manage, and configure multiple user accounts associated with the users 110a-n comprising the sub-network. In an embodiment, the administrator may be allowed to design, configure, and/or manage the appearance of various features including, but not limited to, the map display 610, user pane 804, user profile, user map icon 802, by, for a non-limiting example, including a company logo or brand, using an identifiable color scheme, or any other design feature chosen with sound judgment by a person of ordinary skill in the art.

In an embodiment, the inventive network 100 may include a plurality of differing user-sized closed sub-networks. In an embodiment, the inventive network 100 may allow the creation of a family network, a team network, and a company network. The family network may comprise a closed sub-network that is limited to a N1 number of users 110_{1-N1}. In another embodiment, the family network may be a closed sub-network that is limited to including no more than ten (10) users 110₁₋₁₀. The team network may be a closed sub-network that is limited to a second number N2 of users 110_{1-N}, the second number N2 being greater than the first number N1, as per an embodiment. In another embodiment, the team network may be a closed sub-network that is limited to including no more than fifty (50) users 110₁₋₅₀. The company network may comprise a closed sub-network that is limited to a third number N3 of users 110_{1-N3}, the third number N3 being greater than the first number N1 and the second number N2, as per an embodiment. In another embodiment, the company network may be a closed sub-network that is limited to including no more than one hundred (100) users 110₁₋₅₀. The user-size of a closed sub-network can be determined with sound judgment by a person of ordinary skill in the art.

From a commercial point of view, the inventive network 100 may utilize an automated billing system that is integrated into the sub-networks. The automated billing system may allow users to be charged a monetary amount for accessing the sub-network. The automated billing system may determine the monetary amount charged to the user by various methods including, but not limited to, by minute, by transactions, by requests, by number of users, by media, or any other method chosen with sound judgment by a person of ordinary skill in the art. The automated billing system may allow billing to be conducted by bank, credit card, premium sms, reverse billing, micro billing, or any other method chosen with sound judgment by a person of ordinary skill in the art.

Further, the users 110a-n may access the sub-networks utilizing a mobile enterprise portal (MEP) and/or a desktop enterprise portal (DEP). In an embodiment, the MEP may be substantially similar to the MUP 600 and the DEP may be substantially similar to the DUP.

Logistical Tracking Network

The inventive network 100 can be used as a logistical tracking network that provides the users 110a-n a near real-time view of the location, movement, and key-unit performance data of personnel, cargo, packages, equipment, or any other person or item chosen with sound judgment by a person of ordinary skill in the art, regardless of its possible world-wide location. The logistical tracking network may utilize an operating environment similar to that of the inventive network 100. In an embodiment, the logistical tracking network can be a closed network that can only be accessed by users 110a-n who are authorized to access. The logistical tracking network may utilize a logistic communication device, the MUP 600, and a monitoring station that are in electrical communication with the geo-server 102 or the web server 106. Here, the logistic communication device can be utilized to automatically transmit location, movement, and/or key-unit performance data to the logistical tracking network. In an embodiment, the logistic communication device may comprise a modem that accesses the communications network 118. Next, the MUP 600 collects and transmits location data of the users 110a-n to the logistical tracking network. The user 110a may utilize the MUP 600 to receive the location, movement, and key-unit performance data of the personnel and/or equipment from other users 110b-n via their MUP 600 and from equipment and/or work units via the logistic communication device. The logistical tracking network may receive, store, and aggregate the location, movement, and/or key-unit performance data in a logistical database similar to the database server 104, that can be accessed by the geo-server 102. Now the data can be displayed over the map image 610 for viewing by the users 110a-n.

Security

The inventive network 100 may include a number of security mechanisms to protect the privacy of the users 110a-n from being tracked and the integrity and availability of the information and the services mentioned above. This can be ensured by using many methods known in the existing art. For a non-limiting example, for the purpose of IT security firewall protection can be provided against hacking, spyware, Trojan, virus attacks. Further, in an embodiment, the data uploaded by the users 110a-n can be scanned using any of the existing anti-virus software available. Furthermore, authentication of an user can be required using methods available in the art. Additionally, storage and transmission of data can be encrypted and any unwanted or malicious activity can lead to suspension, deactivation or termination of services, depending upon the severity of the matter.

Uses/Functionalities

The closed networks described above can be utilized for various services and/or by industries, including, but not limited to, courier companies, for example, taxis, pizza delivery, etc.; search and rescue; security; fleet, vehicle, cargo, and asset management; road side assistance services; travel agencies, tourist offices; city and/or venue promotions; parent-child tracking/tracing; healthcare services, for example, tracking alzheimer patients; human aid services; photo-proof services; real estate; insurance; road maintenance services; news and network services, including tracking/tracing reporters, journalists, documentaries, etc.; logistics and maintenance services; dating, matching, and relationship services; animal, flock, herd, and group animal services; and/or game, learning and education services. Additionally, the inventive network 100 can facilitate location-based mobile social networking; location-based blogging/archiving; friend finder services; peer interest reviewer/finder services relating to, for a non-limiting example, restaurants, bars, cities, etc.; city guides; story telling; gaming; news services; reporting services; recipe and cooking; travel and rally races; event reporting and/or live recorder services.

Revenue/Business Model

The inventive network 100 can allow for the collection and aggregation rich, location-relevant data, such as the user-generated geo-marketing data available by tracking and analyzing the usage of the inventive network 100 by the users 110a-n. The inventive network 100 can offer a solution, business proposition, and/or revenue model for providing this user-generated geo-marketing data to interested parties including but not limited to, engineers, planners, marketeers, manufacturers, and/or healthcare providers who have not been able to map, analyze, target or model on this source before. Because substantially all user-data must pass through the one or more database servers 104, the inventive network 100 may facilitate the aggregation of vast, geo-indexed data sets. Because the databases aggregate, filter, and mine the geo-data supplied by the users 110a-n, the database server 104 can provide an innovative business model of supplying geo-data. The aggregated geo-indexed data collected by the inventive network 100 may be utilized for increased business performance including, but not limited to, targeted marketing, marketing research and analysis and/or other marketing purposes; network reliability and integrity testing, research, and analysis; device performance testing, research, and analysis; mobile network performance testing, research, and analysis; and/or social and demographic statistical research.

Further, the inventive network 100 can provide licensing of individual user profiles and/or closed networks. One non-limiting example of such a revenue model for the inventive network 100 may include allowing individual users 110a-n a choice between two levels of access to the inventive network 100. A first level of individual access may comprise a FreeMe access. The FreeMe access may allow the individual user 110a-n free access to the inventive network 100 but may limit the availability of various features of the inventive network 100 including but not limited to, the number of shares the user 110a-n may be allowed to upload and/or the types of shares the user 110a-n may be allowed to upload. For example, the FreeMe user may be prevented from creating collections and/or trips but may be allowed to upload a predetermined number of individual shares. A second level of individual access may comprise a MePlus access. The MePlus access may allow the individual user 110a-n complete access to the inventive network 100 and all of its associated features, but may require the user 110a-n to pay a periodic, for one non-limiting example, monthly, fee. Additionally, the inventive network 100 may generate revenue through allowing users to create closed networks. In an embodiment, users wishing to create and/or administer a closed network may be required to pay a periodic, for one non-limiting example, monthly, fee. In an embodiment, the required fee may depend on the user-size of the closed network and/or the customized features and/or controls available. In an embodiment, the required fee for creating and/or administering a family network may be less than that required for a team network. The required fee for creating and/or administering the team network may be less than that required for a company network. Additionally, the inventive network can generate revenue by charging individual users and/or users creating and/or administering a closed network on a transactional basis wherein the user pays a fee that is determined at least partially on the feature the user desires access to. In an embodiment, the user 110a may pay a first fee for each individual share uploaded, a second fee, greater than the first fee, for creating a collection or a trip, and/or a third fee, greater than the second fee, for access to the live-line feature of the inventive network 100.

Further, the inventive network 100 can amplify the generation of data traffic that can increase the average revenue per user (ARPU) thereby increasing the desirability for business and revenue generate partnerships with network providers and handset manufacturers. For example, a handset manufacturer may wish to include a pre-installed version of the client application software, in order to encourage access into the inventive network 100 thereby increasing the number of users 110a-n resulting in an increased amount of geo-data, in exchange for access to or a reduced rate when purchasing the geo-data generated by the inventive network 100.

Furthermore, the inventive network 100 can generate revenue utilizing a data supply and demand market that allows the users 110a-n to be co-creators and beneficiaries of self-created user data. The inventive network 100 can be utilized to allow for a system of participator data-suppliers and participator demand users. In an embodiment, any participator user may be a participator demand user by posting or publishing a data-demand communication within the inventive network 100. The participator data-suppliers may sign up for a delivery for which they receive a payment, including, but not limited to, credits, cash, and/or coupons, from the participator demand user posting or publishing the data-demand communication. For example, in an embodiment, a participator demand user may post or publish a data-demand communication requesting photos of particular historic landmarks. The data-demand communication may require the photos to be delivered to the participator demand user or to a third party. The data-demand communication may also state the form and method of payment upon delivery of the requested photos. The participator demand user may establish a limit on the number of photos supplied by providing that they will only accept delivery of a specific number of photos or by requiring the participator-suppliers to sign up or obtain prior authorization from the participator demand user prior to supplying the requested photos. In an embodiment, the nimity slider 1100 may be utilized to facilitate and control the process by automatically limiting the number and type of data-demand communications received and/or the information transmitted, visible, or otherwise accessible while conducting a demand transaction.

The foregoing description of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for communication among a plurality of communication devices, wherein the plurality of communication devices are connected through a network, comprising:
receiving data from the plurality of communication devices;
checking the received data for geo-tag;
adding geo-tag to the received data;
storing the geo-tagged data;
distributing the stored geo-tagged data to at least one of the plurality of communication devices; and
displaying the geo-tagged data on the at least one of the plurality of communication devices.

2. The method for communication according to claim 1, further comprising
updating changes in the geo-tagged data; and
sending the updated geo-tagged data to the at least one of the plurality of communication devices.

3. The method for communication according to claim 1, wherein the step of adding further comprising adding geo-tag to the received data, wherein the received data is not geo-tagged.

4. The method for communication according to claim 1, wherein changes in the geo-tagged data are updated and sent to the at least one of the plurality of communication devices in near real-time.

5. The method for communication according to claim 1, wherein changes in the geo-tagged data are updated and sent to the at least one of the plurality of communication devices based on changes in a set of pre-defined settings.

6. The method for communication according to claim 2, wherein updating comprising manually updating the changes in the geo-tagged data.

7. The method for communication according to claim 2, wherein updating comprising automatically updating the changes in the geo-tagged data.

8. The method for communication according to claim 1, wherein displaying further comprising
identifying geographic locations using the geo-tagged data from the plurality of communication devices; and
positioning icons corresponding to the plurality of communication devices on a digital map based on the identified geographic locations.

9. The method for communication according to claim 1, further comprising
generating an unique profile corresponding to each of the plurality of communication devices, wherein the unique profile comprises a pre-defined set of information; and
displaying the pre-defined set of information on the at least one of the plurality of communication devices along with the geo-tagged data corresponding to each of the plurality of communication devices.

10. The method for communication according to claim 9, wherein displaying comprises showing the pre-defined set of information based on a pre-defined set of privacy settings.

11. The method for communication according to claim 10, wherein the set of privacy settings can be automatically defined using an algorithm, wherein the algorithm monitors, remembers and analyzes changes over time in a set of preferences by a user of the at least one of the communication devices.

12. The method for communication according to claim 1, further comprising
defining a set of parameters, wherein the set of parameters is defined by a first communication device of the plurality of communication devices;
requesting information about one or more of the plurality of communication devices from the network based on the defined set of parameters; and
receiving information from the network.

13. The method for communication according to claim 12, wherein receiving further comprising receiving information based on a pre-defined set of rules on information sharing corresponding to each of the plurality of computational devices.

14. The method for communication according to claim 8, wherein displaying further comprising showing the geo-tagged data on a digital map based on a pre-defined set of preferences.

15. The method for communication according to claim 1, further comprising allowing a first communication device of the plurality of communication devices to exchange data with one or more of the plurality of communication devices.

16. The method for communication according to claim 1, wherein the plurality of communication devices form a group, wherein the group is not accessible by

17. A system for communication, comprising:
a plurality of communication devices connected through a network; and
a first server communicatively connected with the network, wherein the first server receives data from the plurality of communication devices, adds geo-tag to the received data and stores the geo-tagged data, and wherein the first server distributes the stored geo-tagged data to at least one of the plurality of communication devices.

18. The system for communication according to claim 16, wherein the first server adds geo-tag to the received data, wherein the received data is not geo-tagged.

19. The system for communication according to claim 16, wherein the first server updates changes in the geo-tagged data, and wherein the first server sends the updated geo-tagged data to the at least one of the plurality of communication devices.

20. The system for communication according to claim 18, wherein changes in the geo-tagged data are updated in near real-time.

21. The system for communication according to claim 18, wherein changes in the geo-tagged data are updated based on changes in a set of pre-defined settings.

22. The system for communication according to claim 16, wherein the first server comprises
a web server, wherein the web server comprises a network engine, wherein the network engine implements a server application software to execute the system for communication on the network; and
a geo-server, wherein the geo-server receives data, adds geo-tag to the received data, stores the geo-tagged data and distributes the stored geo-tagged data to be displayed on the display of the at least one of the plurality of communication devices.

23. The system for communication according to claim 22, wherein the geo-server comprises
a location detecting capability module, wherein the location detecting capability module detects geographical locations of the plurality of communication devices;
a content management system, wherein the content management system provides an interface to access, manipulate and manage the data, and wherein the content management system facilitates addition of geo-tag to the data based on the geographical location determined by the location detecting capability module; and
a database server, wherein the database server receives the data, stores the geo-tagged data and distributes the stored geo-tagged data to be displayed on the display of the at least one of the plurality of communication devices.

24. The system for communication according to claim 16, wherein at least one of the plurality of communication devices comprises
a memory for storing data;
a processor for executing code to implement a client application software to connect to the system for communication on the network; and
a display, wherein the geo-tagged data distributed by the first server is displayed on the display.

25. The system for communication according to claim 16, wherein one or more of the plurality of communication devices comprises a geo-source, wherein the geo-source adds geo-tag to a data, and wherein the geo-source automatically updates and stores changes in the geo-tagged data.

26. The system for communication according to claim 16, further comprising a third party database server, wherein the third part database server contains geo-enriched data.

27. The system for communication according to claim 16, wherein the first server is communicatively coupled to the third party database server.
